(19) United States
(12) Patent Application Publication
(10) Pub. No.: US 2008/0285273 A1
(43) Pub. Date: Nov. 20, 2008

(54) LED TABLE LAMP

(75) Inventors: Chien-Hua Liu, Taipei (TW); Heng-Chun Huang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AMA PRECISION INC., Taipei (TW)

(21) Appl. No.: 12/116,974

(22) Filed: May 8, 2008

(30) Foreign Application Priority Data
May 16, 2007 (TW) 96117436

(51) Int. Cl. F21V 21/00

(52) U.S. Cl. 362/240; 362/249

(57) ABSTRACT

An LED table lamp including a base, a holder, and a light emitting device is provided, wherein an end of the holder is connected to the base. The light emitting device includes a lampshade connected to the other end of the holder, multiple Lambertian LED light source assemblies, multiple side-emitting LED light source assemblies, a transparent support provided at the lampshade, and multiple brightness enhancement films (BEF). The lampshade has a side wall and a top wall connected the side wall, and the Lambertian LED light source assemblies and the side-emitting LED light source assemblies are disposed on the top wall. The BEFs are disposed on the transparent supports correspondingly to the Lambertian LED light source assemblies and are suitable to focus the light emitted from the Lambertian LED light source assemblies.

### CROSS-REFERENCE TO RELATED APPLICATION

This application claims the priority benefit of Taiwan application serial no. 96117436, filed on May 16, 2007. The entirety of the above-mentioned patent application is hereby incorporated by reference herein and made a part of specification.

### BACKGROUD OF THE INVENTION

1. Field of the Invention

The invention relates to a table lamp and, more particularly, to a light emitting diode (LED) table lamp.

2. Description of the Related Art

In the daily life, people usually utilize a table lamp to enhance the light of an area where the light is weaker in a room. Therefore, the area with insufficient light such as a desk can have a bright working environment, and then a user can read or do other things at the desk without worrying about that the eye sight may go because of the insufficient working environment.

Generally speaking, since a light emitting diode (LED) light source has a small size and a long service life, it has been used more and more popularly. FIG. 1 is a schematic diagram showing a conventional LED table lamp. Please refer to FIG. 1, the light source 110 of the LED table lamp 100 is composed of a plurality of Lambertian LEDs, the light emitted by the Lambertian LEDs can be shined on the working or reading environment directly to provide a preferred illumination.

Since the light source of the LED table lamp 100 is completely composed of Lambertain LEDs, and the light emitted by the Lambertian LEDs is directly emitted to the outside of the lampshade 120, the brightness of the LED table lamp 100 is easy to be too high. When a user reads or works, the light directly emitted to the working environment by the Lambertain LEDs is easy to be directly emitted to the eyes of the user, which cause the eyes of user uncomfortable.

FIG. 2 is a schematic diagram showing another kind of a conventional LED table lamp. Please refer to FIG. 2. The light source 210 of the LED table lamp 200 is completely composed of side-emitting LEDs. The light emitted by the side-emitting LEDs is emitted to the outside of the lampshade 220 after the light is reflected by the reflecting films in the lampshade 220. Therefore, the light emitted by the LED table lamp 200 is not easy to be directly emitted to the eyes of the user to cause the eyes uncomfortable. However, the intensity of the light reflected to the outside of the lampshade 220 by the reflecting film is weaken, and therefore, the light illumination in the working environment or the reading environment is easy to insufficient. That is, when the LED table lamp 200 with the side-emitting LEDs is used, the light usage rate is not preferred.

In addition, the number of the side-emitting LEDs of another conventional LED table lamp (not shown) is increased greatly to increase the light illumination in the working environment. However, it increases the cost of the LED table lamp.

### BRIEF SUMMARY OF THE INVENTION

The invention provides a light emitting diode (LED) table lamp which can generate light with evener brightness to resolve the problem that the brightness of the LED table lamp is too high.

The invention relates to a LED table lamp which can resolve the problem that the illumination of the working or reading environment is not sufficient.

The invention provides a LED table lamp whose brightness can conform to the illumination standard with a low manufacturing cost.

The invention provides a LED table lamp including a base, a holder and a light emitting device. One end of the holder is connected to the base, and the light emitting device includes a lampshade pivotally connected to the other end of the holder, a plurality of Lambertian LED light source assemblies, a plurality of side-emitting LED light source assemblies, a transparent support provided at the lampshade and a plurality of brightness enhancement films (BEF).

The lampshade has a side wall, a top wall connected to the side wall and a light outlet section corresponding to the top wall, and the Lambertian LED light source assemblies and the side-emitting LED light source assemblies are provided at the top wall. In addition, the BEFs are corresponding to the Lambertian LED light source assemblies and provided at the transparent support to focus the light emitted by the Lambertian LED light source assemblies.

In one embodiment, the light emitting device further includes a lens provided at the light outlet section to even the light emitted by the Lambertian LED light source assemblies and side-emitting LED light source assemblies.

In one embodiment of the invention, the lens is a diffusion lens.

In one embodiment of the invention, the transparent support is provided at the side wall of the lampshade and is parallel to the top wall of the lampshade.

In one embodiment of the invention, the side-emitting LED light source assemblies are provided at the peripheral area of the top wall, while the Lambertian LED light source assemblies are provided at the central area of the top wall.

In one embodiment of the invention, the light emitting device further includes a reflecting film provided at the top wall and the side wall of the lampshade. The reflecting film and the lampshade are preferred to be integrally formed. For example, the inner side wall of the lampshade made of material with a higher reflectance has the effect like a reflecting film.

In one embodiment of the invention, the BEFs are provided at the light outlet route of the Lambertian LED light source assemblies.

In the invention, the light source of the LED table lamp is composed of the side-emitting LED light source assemblies and the Lambertian LED light source assemblies. The Lambertian LED light source assemblies provided at the central area of the top wall can provide the preferred illumination for the working or reading environment. In addition, since only the plurality of Lambertian LED light source assemblies are provided in the LED table lamp to increase the illumination of the environment in the invention, compared with the conventional LED table lamp which completely uses Lambertian LED light source assemblies as light sources, the LED table lamp of the invention has proper brightness.

Since the LED table lamp of the invention has a plurality of Lambertian LED light source assemblies which can improve the environment illumination, the invention can improve the condition that the cost of the table lamp is greatly increased with the increase of the number of the side-emitting LEDs.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a conventional light emitting diode (LED) table lamp.

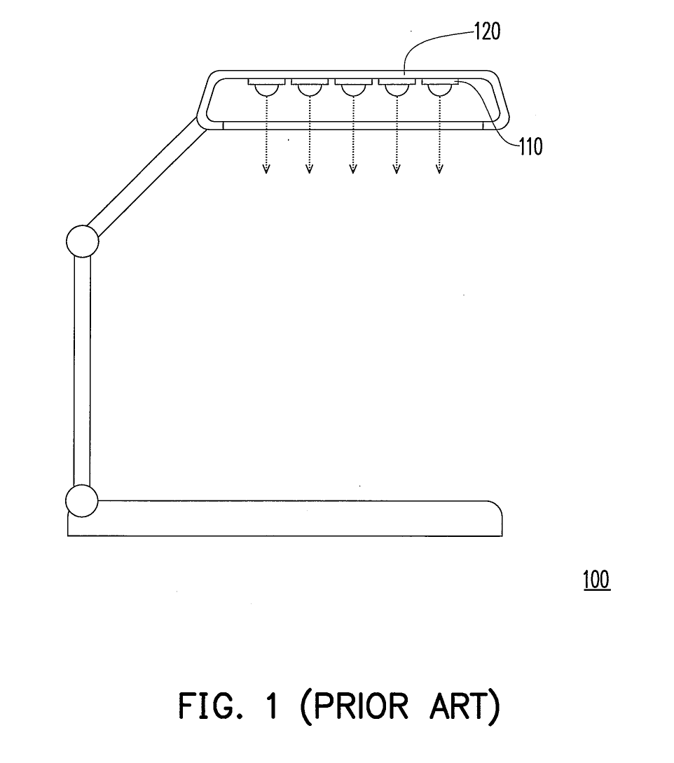

FIG. 2 is a schematic diagram showing an another conventional LED table lamp.

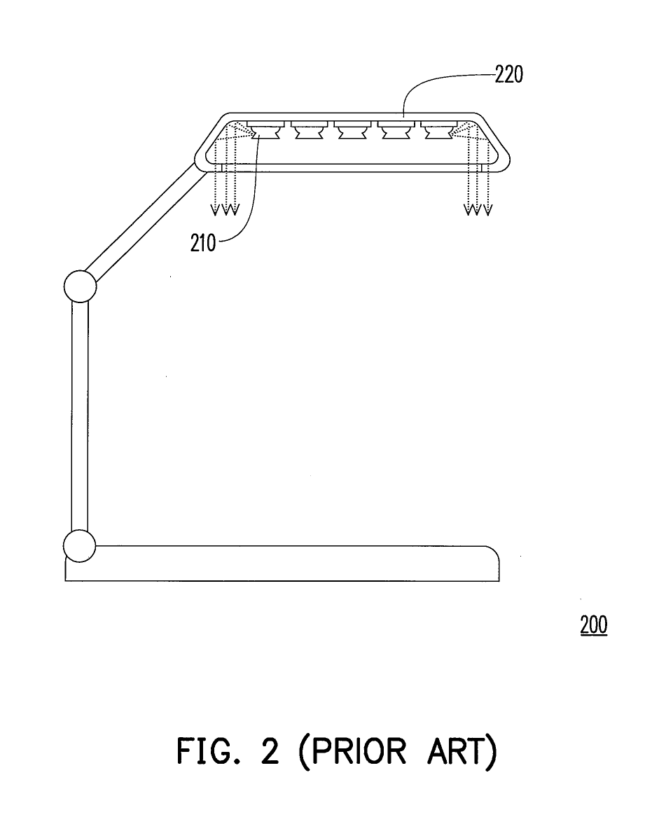

FIG. 3 is a schematic diagram showing the LED table lamp of an embodiment of the invention.

### DETAILED DESCRIPTION OF THE EMBODIMENT

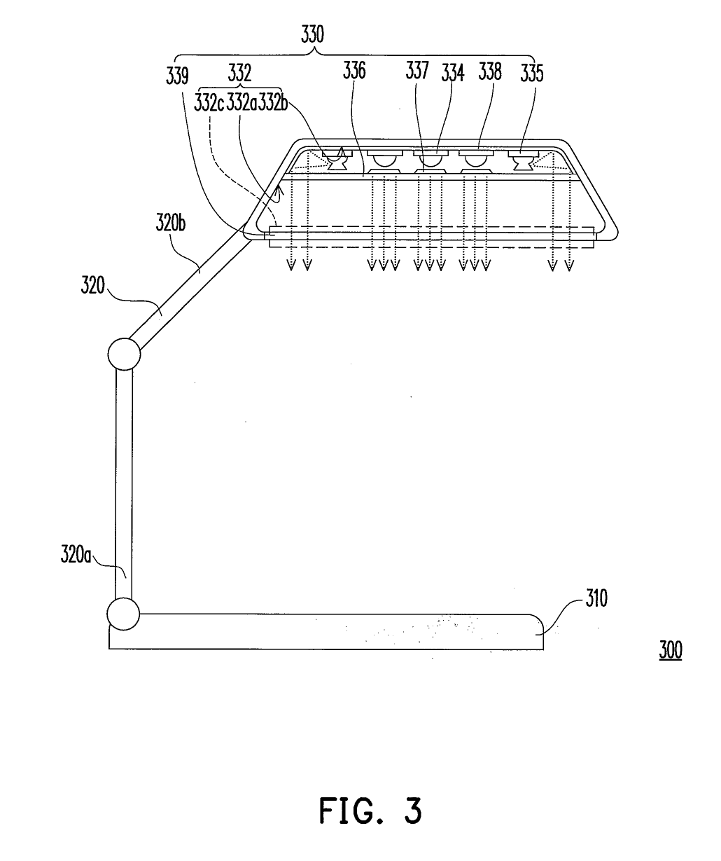

FIG. 3 is a schematic diagram showing the LED table lamp of an embodiment of the invention. Please refer to FIG. 3. The LED table lamp 300 of the embodiment includes a base 310, a holder 320 and a light emitting device 330. One end 320a of the holder 320 is connected to the base 310, and the light emitting device 330 is pivotally connected to the other end 320b of the holder 320. The user can adjust the direction of the light emitted by the light emitting device 330, so that the desk of the user can have a brighter reading or working environment. The light emitting device 330 of the embodiment of the invention is described in detail hereinbelow.

Please refer to FIG. 3. The light emitting device 330 of the embodiment mainly includes a lampshade 332 pivotally connected to the end 320b of the holder, a plurality of Lambertian LED light source assemblies 334, a plurality of side-emitting LED light source assemblies 335, a transparent support 336 provided at the lampshade 332 and a plurality of brightness enhancement films (BEF) 337. The lampshade 332 has a side wall 332a, a top wall 332b connected to the side wall 332a and a light outlet section 332c corresponding to the top wall 332b, and the Lambertian LED light source assemblies 334 and the side-emitting LED light source assemblies 335 are provided at the top wall 332b.

The light energy of the side-emitting LEDs often focuses at a zone 60 to 120 degrees deflected from the normal line of the LED light outlet surface. In the embodiment, the side-emitting LED light source assemblies are, for example, provided at the peripheral area of the top wall 332b, and the Lambertian LED light source assemblies 334 are, for example, provided at the central area of the top wall 332b. The Lambertian LED light source assemblies 334 provided at the central area of the top wall 332b is suitable to emit the light to the outside of the lampshade 332 to improve the light illumination of the working or reading environment. Since the light of the Lambertian LED light source assemblies 334 is diffused, the BEFs 337 corresponding to the Lambertian LED light source assemblies 334 are provided in the invention to effectively focus the light emitted by the Lambertian LED light source assemblies 334 in a proper range of the working or reading environment.

In detail, the BEFs 337 are provided on the transparent support 336 correspondingly to the Lambertian LED light source assemblies 334 in the embodiment. The transparent support 336 is, for example, provided at the side wall 332a and parallel to the top wall of the lampshade to make the BEFs 337 provided on the light outlet route of the Lambertian LED light source assemblies 334. In this way, the BEFs 337 can effectively focus the light emitted by the Lambertian LED light source assemblies 334 in the working or reading environment to be beneficial for the working or reading.

The BEFs 337 are, for example, embedded on the transparent supports 336. Certainly, in other preferred embodiment, the BEFs 337 also can be provided on the transparent supports 336 in other modes.

In addition, a reflecting film 338 can be provided at the top wall 332b and the side wall 332a of the embodiment to effectively reflect the light emitted by the side-emitting LED light source assemblies 335 to the outside of the lampshade 332. The reflecting film 338 is preferred to be integrally formed with the lampshade. For example, the lampshade is made of material with a high reflectance, and then the inner surface of the lampshade can have the effect like the reflecting film.

To make the light generated by the LED table lamp 300 gentle, a lens 339 such as a diffusion lens is provided at the light outlet section 332c of the lampshade 332 to make the light emitted by the Lambertian LED light source assemblies 334 and the side-emitting LED light source assemblies 335 even, and then the LED table lamp 300 can generate the gentle light.

Although the side-emitting LED light source assemblies 335 are provided at the peripheral area of the top wall 332b in the embodiment, and the Lambertian LED light source assemblies 334 are provided at the central area of the top wall 332b, in other embodiments, the Lambertian LED light source assemblies 334 and the side-emitting LED light source assemblies 335 also can be provided alternately, which is not limited in the invention.

To sum up, the light source of the LED table lamp is composed of side-emitting LED light source assemblies and the Lambertian LED light source assemblies. The light emitted by the Lambertian LED light source assemblies can be focused in the working or reading area by the BEFs to be beneficial for the working or reading. That is, the light illumination of the working or reading environment can be effectively improved in the invention to improve the condition that the light illumination of the working or reading environment is not preferred for the light sources of LED table lamp is completely composed of the side-emitting LED light source assemblies.

In addition, since only a plurality of Lambertian LED light source assemblies are added in the invention, which can resolve the problem that light illumination of the working or reading environment is not preferred, and a plurality of side-emitting LED light source assemblies are not needed to be added greatly to increase the light illumination of the working or reading environment, compared with conventional technology, the number of the LED light source assemblies which are needed to be provided is decreased, and the manufacturing cost of the LED table lamp is decreased.

Since only a plurality of Lambertian LED light source assemblies are provided at the LED table lamp to increase the environment illumination, compared with the conventional LED table lamp which uses Lambertian LED light source assemblies completely as its light source, the LED table lamp of the invention has proper brightness. In other word, the LED table lamp of the invention can provide gentler light, and the light emitted by the LED table lamp is not easy to be emitted to the eyes of a user and cause the eyes uncomfortable.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A light emitting diode (LED) table lamp comprising:
a base;
a holder, wherein one end of the holder is connected to the base; and
a light emitting device comprising:
a lampshade pivotally connected to the other end of the holder,
wherein the lampshade comprises:
a side wall;
a top wall connected to the side wall;
a plurality of Lambertian LED light source assemblies provided at the top wall;
a plurality of the side-emitting LED light source assemblies provided at the top wall;
a transparent support provided in the lampshade; and
a plurality of brightness enhancement films (BEF) corresponding to the Lambertian LED light source assemblies and provided on the transparent support.

2. The LED table lamp according to claim 1, wherein the lampshade comprises a light outlet section and the light emitting device further comprises a lens provided at the light outlet section.

3. The LED table lamp according to claim 2, wherein the lens is a diffusion lens.

4. The LED table lamp according to claim 1, wherein the transparent support is provided at the side wall of the lampshade and parallel to the top wall of the lampshade.

5. The LED table lamp according to claim 1, wherein the side-emitting LED light source assemblies are provided at the peripheral area of the top wall, and the Lambertian LED light source assemblies are provided at the central area of the top wall.

6. The LED table lamp according to claim 1, wherein the light emitting device further comprises a reflecting film provided at the top wall and the side wall of the lampshade.

7. The LED table lamp according to claim 6, wherein the reflecting film and the lampshade are integrally formed.

8. The LED table lamp according to claim 1, wherein the BEFs are provided at the light outlet route of the Lambertian LED light source assemblies.
